(19) United States
(12) Patent Application Publication
(10) Pub. No.: US 2010/0329514 A1
(43) Pub. Date: Dec. 30, 2010

(54) TOMOGRAPHIC IMAGING MOTION SCAN QUALITY RATING

(76) Inventor: Uwe Mundry, Landrum, SC (US)

Correspondence Address: MICHAEL BEST & FRIEDRICH LLP, 100 E WISCONSIN AVENUE, Suite 3300, MILWAUKEE, WI, 53202, US

(21) Appl. No.: 12/918,554

(22) PCT Filed: Feb. 20, 2009
(86) PCT No.: PCT/US09/34682

§ 371 Date: Aug. 26, 2010

Related U.S. Application Data
(60) Provisional application No. 61/030,217, filed on Feb. 20, 2008.

(51) Int. Cl. G06K 9/00

(52) U.S. Cl. 382/107

(57) ABSTRACT

A method for determining if an object of a scan generated by a movable scanner has moved by comparing images generated at a plurality of orientations of the movable scanner and information related to such images. The object is scanned at a first orientation of the movable scanner, and scanned a second time at the first orientation of the movable scanner. A first brightness quantity is generated based on scanning the object at the first orientation, and a second brightness quantity is generated based on scanning the object the second time at the first orientation. The method also includes determining a motion factor based on the first brightness quantity, the second brightness quantity, and first and second images generated at the first orientations of the movable scanner.

### RELATED APPLICATIONS

This application claims priority to U.S. Provisional Patent Application No. 61/030,217 filed on Feb. 20, 2008, the contents of which are included herein by reference.

### TECHNICAL FIELD

The invention relates to tomographic imaging, and especially, but not exclusively, to X-ray tomographic dental imaging.

### BACKGROUND

There are various ways to obtain three-dimensional data relating to a property of an object that varies over space within the object. For example, an X-ray image of a target may be obtained by placing the target between a source of X-rays and a detector of the X-rays. In a computed tomography (CT) system, a series of X-ray images of a target are taken with the direction from the source to the detector differently oriented relative to the target. From these images, a three-dimensional representation of the density of X-ray absorbing material in the target may be reconstructed. Other methods of generating a three-dimensional dataset are known, including magnetic resonance imaging, or may be developed hereafter.

When acquiring tomographic X-ray data of an object, views from many angles are desired. For example, data is acquired 360 degrees around the object. This is accomplished by rotating either the object or the X-ray equipment relative to the other. Machinery that rotates the object or the X-ray equipment is built to precise standards, with the goal of achieving pure rotation about an axis, with no other movement. The precision of the machines continues to improve.

However, unexpected movements may occur during the scan. If either the machine is moved on its base, or the object moves, the data is rendered less accurate than it should be. Inanimate objects are unlikely to move. On the other hand, a patient, such as one undergoing panoramic dental X-ray imaging, is prone to movement. The patient can move in six ways: three rotational movements, and three translational movements. One predominant way that patients move is by a rotation from front to back, similar to dropping or raising the chin.

It is desirable to detect whether movement has occurred, and if it has, to what magnitude. It is further desirable to determine whether the movement is localized in a non-critical area. For example, if the dentist only seeks a clear image of teeth on the upper jaw, but the lower jaw moves independent of the upper, then the dentist would not be concerned.

Detection of movement allows the dental practitioner, or other X-ray technician, to discard the data if necessary. The technician can then take another series of images. One method that is available is for the practitioner to look at two scans taken from the same orientation, and use their own eyes to assess if they are satisfied that the object did not move. Some machines are configured to make these two images readily available for visual comparison. However, the practitioner could benefit from a more precise evaluation method.

### SUMMARY

In accordance with one aspect of the invention, the quality of images produced by a scanner is assessed by determining if an object of a scan has moved, by comparing the image captured by the scanner at two different times.

In one construction, the two images are taken from the same orientation, so that the images are substantially identical if no movement occurred. In another construction, the images are taken at different orientations and a prediction is made from the first image, or multiple images, to determine how the second image should appear in the absence of movement.

The comparison of the images is accomplished by calculating a mean brightness m1 of the image from the first orientation, and a mean brightness m2 of the image at the first orientation at a subsequent time, calculating a brightness delta, creating a subtraction map, overlaying a grid, and determining a motion factor.

The quality of images produced by a scanner is assessed by determining if an object of a scan has moved, by comparing the image captured by the scanner at two times. In one embodiment, the two images are taken from the same orientation, so that they should be identical if no movement occurred. In other embodiments, the images are taken at different orientations and a prediction is made from the first image, or multiple images, how the second image should appear in the absence of movement. In the detailed embodiment, the comparison of the images proceeds by calculating the mean brightness m1 of the image from the first orientation, and the mean brightness m2 of the image from the subsequent image at the first orientation, calculating the brightness delta, creating a subtraction map, overlaying a grid, and determining a motion factor.

In another construction, the invention provides a method for determining if an object of a scan generated by a movable scanner has moved by comparing images generated at a plurality of orientations of the movable scanner and information related to such images, the method comprising: scanning the object at a first orientation of the movable scanner; scanning the object a second time at the first orientation of the movable scanner; generating a first brightness quantity based on scanning the object at the first orientation; generating a second brightness quantity based on scanning the object the second time at the first orientation; and determining a motion factor based on the first brightness quantity, the second brightness quantity and first and second images generated at the first orientation of the movable scanner.

In another embodiment, the invention provides an apparatus for acquiring tomographic x-rays of an object, the apparatus comprising: a source of x-rays for directing x-rays to the object; a detector for sensing the x-rays generated by the source; a gantry having an axis of rotation for rotating the source and detector about the axis; and a processor connected to the gantry, source and detector, the processor being operable to control the apparatus for scanning the object at a first orientation of the gantry, scanning the object a second time at the first orientation of the gantry, generating a first brightness quantity based on scanning the object at the first orientation, generating a second brightness quantity based on scanning the object the second time at the first orientation, and determining a motion factor based on the first brightness quantity, the second brightness quantity and first and second images generated at the first orientation of the gantry.

The above and other objects and advantages of the present invention will be made apparent from the accompanying drawings and the description thereof.

### BRIEF DESCRIPTION OF THE FIGURES

The accompanying drawings, which are incorporated in and constitute a part of this specification, illustrate embodiments of the invention and, together with a general description of the invention given above, and the detailed description of the embodiments given below, serve to explain the invention.

FIG. 1 illustrates a dental tomographic imaging device that incorporates an embodiment of the invention.

FIG. 2 is a schematic a top view of a patient in the device of FIG. 1.

FIG. 3 is a flow chart of a process according to the invention.

### DETAILED DESCRIPTION OF THE ILLUSTRATIVE EMBODIMENTS

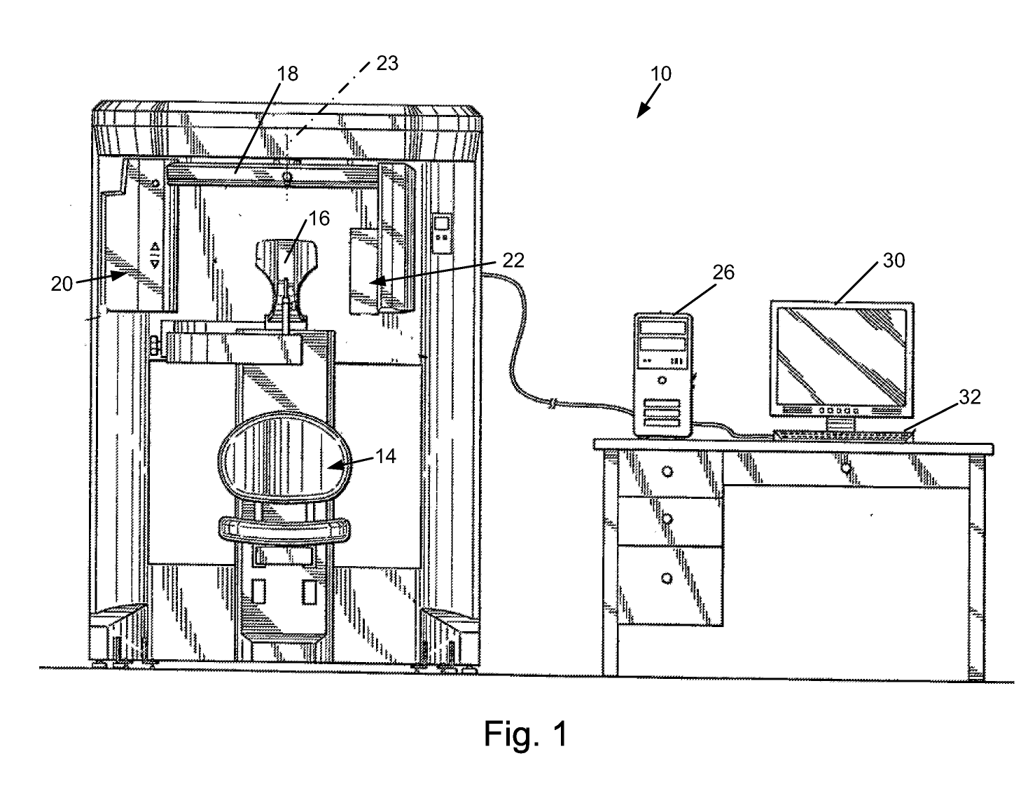

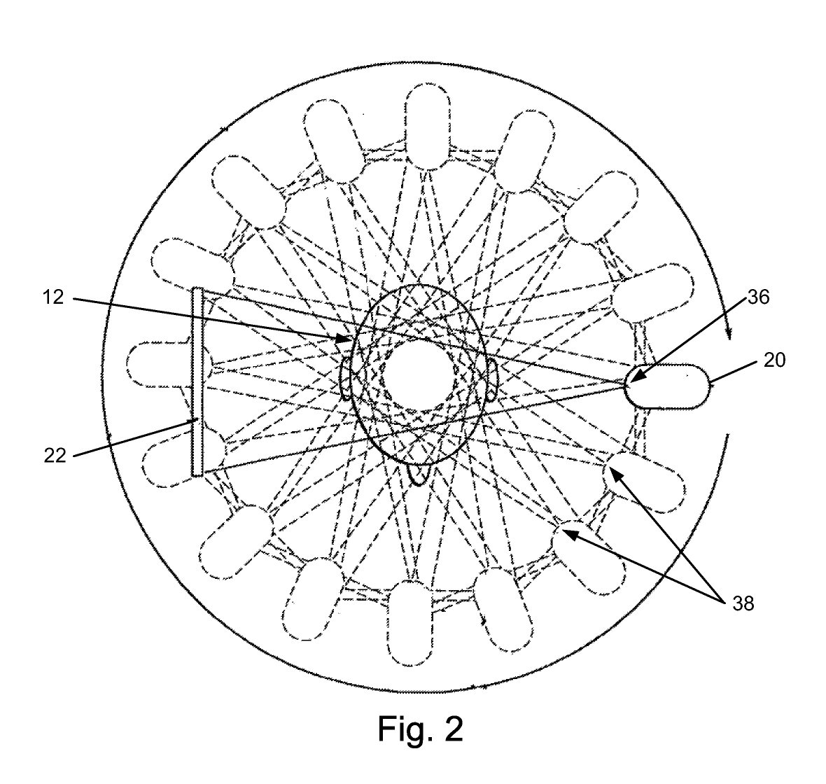

FIGS. 1 and 2 illustrate an exemplary X-ray tomography machine 10 including, among other things, a rotatable gantry 18 with an X-ray source 20 and a detector 22. The machine 10 is designed such that a patient 12 sits on a seat 14 and rests his/her head on a support 16 while the gantry 18 rotates the X-ray source 20 and detector 22 around the patient 12 with respect to an axis 23. As illustrated in FIG. 2, according to one aspect of the invention, data is taken at a number of angular locations (referred to also as views, orientations, or frames) around the patient 12. For example, the gantry 18 may be rotated with respect to the patient 12 and stopped for data collection at angular locations that vary at 1 degree increments for a total of 361 data collection points. The detector 22 generates a signal at each data collection point and sends the signal to a processor 26. The processor 26 includes software to process the signal sent by the detector 22 and to form an image of the patient's structures such as teeth, bone, and tissue. In the illustrated construction, the image is displayed on output screen 30. A user may operate the processor 26 via an input console 32 for displaying the image and for operating other functions of the processor 26 and the machine 10.

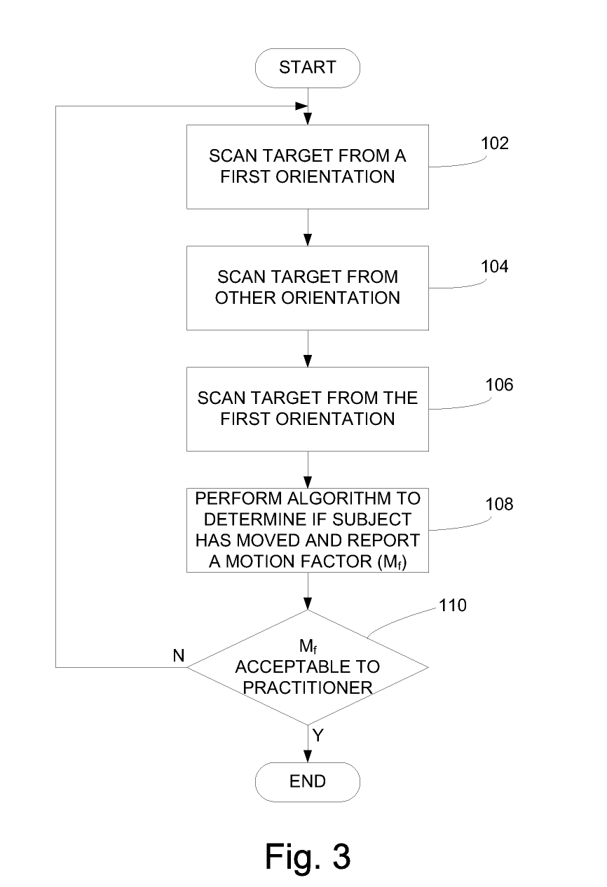

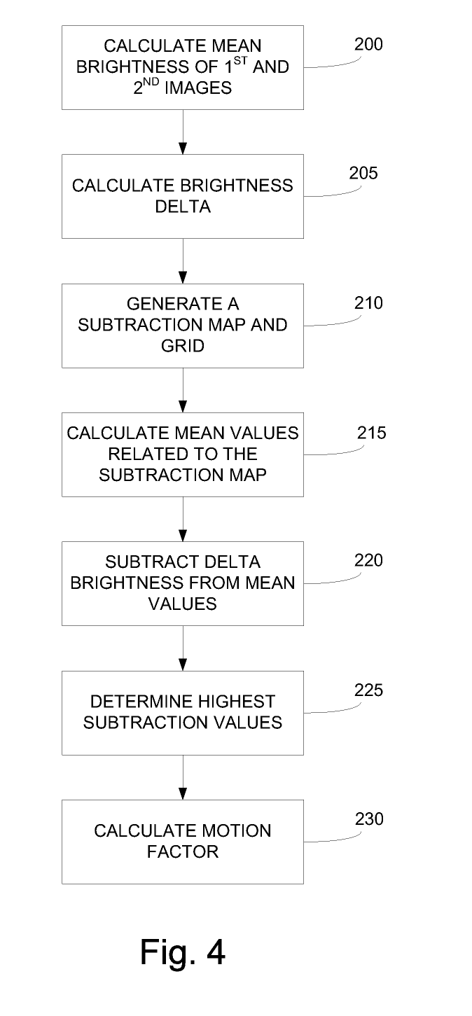

According to one embodiment of the invention, the software in the processor 26 includes an algorithm to determine whether a part of the patient 12 that is scanned has moved during the data collection process. FIG. 3 illustrates a flow chart describing the software including the algorithm. According to the flow chart, the machine 10 performs a scan at a first orientation or position 36 (step 102), as illustrated in FIG. 2. The machine 10 then performs another scan at another orientation (step 104) different than the first orientation. The machine 10 repeats step 104 based on a number of data collection points (orientations) necessary to complete at least a full rotation of the source 20 and detector 22 around the patient 12. The number of data collection points may be predetermined by the algorithm or may be chosen by a user via the console 32 and processor 26.

The machine 10 proceeds to perform another scan at the first orientation 36 (step 106). A first image generated from the first scan (step 102), at zero degrees rotation, and a second image generated from the scan at the same orientation (step 106), at 360 degrees rotation, should be substantially identical if no movement has occurred, and if other variables are eliminated or accounted for. The data corresponding to the first image and the second image is compared and a motion factor is calculated (step 108), as further described below. The user or practitioner then determines whether or not the motion factor is at an acceptable level (step 110). If the practitioner determines the motion factor is unacceptable, then the scanning process is repeated starting with data collection at the first orientation (step 102). If the practitioner determines the motion factor is acceptable, then the scanning process is ended. Alternatively, images generated from scans at orientations other than the first orientation 36 may be used in generating the motion factor.

The invention also encompasses the process of comparing data from scans at difference orientations. More specifically, comparing data corresponding to scans at two different orientations allows the detection of movement resulting from a) the rotation of the gantry 18 and b) the undesirable movement of the patient 12. The software allows predicting and/or projecting changes between images from the two scans at different orientations resulting from the rotation of the gantry 18. The predicted changes may be subtracted from the total movement detected between the two images such that the undesirable movement of the patient 12 is apparent.

The process of determining undesired movement as described above may be performed in tomography that does not involve a full rotation of the gantry 18 about the patient 12. For example, one process defined as “half scan” methodology may be implemented where the scanning is performed with a rotation of the gantry 18 spanning about 180 degrees (plus the cone angle of the x-ray beam). For such scans, a comparison between images generated from scans separated by 360 degrees does not exist. In place of such comparison, a motion expectation model is generated to predict the image at a particular frame or orientation based upon a reconstruction performed from a single or multiple prior frames. Subsequently, a comparison is performed between the motion expectation model and the actual image captured to determine a motion quality factor.

In a scanning process according to the invention, the use of the first and last images of the scan sequence allows detecting movement of the patient 12 during the scanning process. Because the magnitude of the movements being detected is relatively small (on the order of 100 microns), the patient 12 may not return to an exact previous location making the comparison between intermediate images (images generated between first and last scans) unnecessary. If the first and last scans are performed at the side of the head (e.g., location 36 in FIG. 2), such scans are sensitive to front to back movement of the patient 12. Accordingly, using images from the first and last scans taken at the same orientation on the side of the head may be preferred. However, it is contemplated that a more frequent comparison of images may be utilized where the images are generated from scans at different orientations.

One exemplary algorithm for comparing two images generated during a scanning process (e.g., the first image and last image) provides a qualitative assessment, termed a Motion Factor (Mf). The algorithm includes calculating the mean brightness of the first frame (m1) and of the last frame (m2). The first frame and last frame are taken at exactly the same focal spot or location. For example, at 0 degrees and at 360 degrees of the rotating acquisition frame. The algorithm also includes calculating the Brightness delta (Bd) as the difference m2−m1. The Bd is a measure for the difference in X-ray intensity between the start of the scan and the end of the scan. There are various reasons why the X-ray intensity may change.

The higher the value of Bd, the higher the probability that Hounsfield Units (HU) are off in the reconstructed imagery, even on a best calibrated system. Spatial resolution on the other hand is not influenced by Bd. The algorithm also includes the step of creating a map of the difference between the last and the first frames. It is to be noted that the number of pixels in the first frame, the number of pixels in the last frame and the number of pixels in this subtraction map are identical. Accordingly, in a case where there is substantially no motion from the patient 12, no X-ray fluctuation and no acquisition noise, the subtraction map contains substantially all zeros. A display of this map would show one homogeneous gray level. In practice, the subtraction map generally shows some basic random pattern as a result of X-ray fluctuation and acquisition noise, and also the effect of Bd.

The algorithm further includes the process of overlaying a grid (for example, one that is 5×5) onto the subtraction map and calculating a mean value for each block of the subtraction map defined by the grid. In the particular example of a 5×5 grid, there are 25 mean values calculated related to the subtraction map. The algorithm includes then subtracting the previously calculated Bd from each of the 25 mean values, thus generating 25 difference values, finding the 4 highest difference values from the 25 difference values, and creating the standard deviation of these 4 highest difference values. The standard deviation so calculated is the Mf. The algorithm as previously described helps reducing the influence of Bd on the Mf calculation.

Testing shows that the sensitivity of the Mf calculation is greatly increased by the process of grid partitioning. In other words, the process of overlaying a grid on a subtraction map. Grid partitioning allows “zooming into” or focusing on the areas (or grid blocks) that show the highest difference between images due to motion. Grid partitioning also allows reducing the smoothing effect in the process of calculating the Mf caused by areas that show substantially no moved between images. In one example, the process of grid partitioning allows focusing on the areas showing mandible movement of the patient 12 while reducing the effects or influence (in calculating the Mf) of other areas that show no movement of the patient 12.

The invention encompasses the implementation of a test series to optimize the grid density and the number of means used for standard deviation calculation vs. sensitivity of the method. Further, the algorithm can be modified or developed further by working with known amounts of movement, purposefully created. Known amounts of movement, created purposefully, may also be used in a calibration process.

It is contemplated that the algorithm may be used for purposes other than the detection of poor quality imaging caused by motion of a patient during the scanning process. Particularly, the algorithm may be used to identify or determine a quality factor (Qf). In additional embodiments, the algorithm may apply a weighting factor to the brightness difference measured in particular grid sections. For example, grid sections that are most likely to have brightness differences merely due to changes in orientation of the scanner would be weighted lower. Similarly, grid sections that are likely to have brightness differences due to motion of the patient or object being imaged would be weighted higher. Applying a weighting factor allows the algorithm to better “zoom into” or focus on the areas with brightness differences most likely to be indicative of patient/object movement.

FIG. 4 is a flow chart of illustrating step 108 of the process shown in FIG. 3 is greater detail. Calculation of the motion factor includes the steps of calculating first and second mean brightness values (step 200) related to images generated at steps 102 and 106 in FIG. 3 and calculating a delta brightness value (205) based on the first and second mean brightness values. In one construction, calculating the delta brightness value includes subtracting the second mean brightness value from the first brightness value. The algorithm in FIG. 4 also includes the step of generating a subtraction map (step 210) by comparing the images generated at steps 102 and 106. Generating the subtraction map (step 210) also includes defining the subtraction map in a grid for differentiation different areas of the subtraction map.

Once the subtraction map is generated in step 210, local mean brightness values related to the subtraction map are calculated (step 215). The mean brightness value of each block or quadrant in the grid of the subtraction map is determined. In one alternative, step 215 includes applying a weighting factor to each of the local mean brightness values. The weighting factor is used to differentiate blocks or areas of the grid more likely affected by motion of the scanning apparatus (e.g., tomography machine 10) and blocks or areas of the grid more likely affected by motion of the object being scanned (e.g., patient 12). For this particular example, the weighting factor related to the motion of the object is greater than the weighting factor related to the motion of the apparatus.

The delta brightness value is subtracted from each of the local mean brightness values (step 220). Once the subtraction is complete, a number of the local delta brightness values are selected. In particular, the number of local delta brightness values is selected to correspond to the highest values of the total local delta brightness values (step 225). In some embodiment, the number of selected local delta brightness values is a predetermined quantity. However, in other embodiments, the number is selected or calculated by the apparatus or the user based on the calibration parameters. The number is a natural number. A motion factor is calculated (step 230) by determining the standard deviation of the selected number of local delta brightness values.

While the present invention has been illustrated by a description of various embodiments and while these embodiments have been described in considerable detail, other embodiments are possible. Accordingly, departures may be made from such details without departing from the spirit or scope of applicant's invention.

What is claimed is:

1. A method for determining if an object of a scan generated by a movable scanner has moved by comparing images generated at a plurality of orientations of the movable scanner and information related to such images, the method comprising:
scanning the object at a first orientation of the movable scanner;
scanning the object a second time at the first orientation of the movable scanner;
generating a first brightness quantity based on scanning the object at the first orientation;
generating a second brightness quantity based on scanning the object the second time at the first orientation; and
determining a motion factor based on the first brightness quantity, the second brightness quantity and first and second images generated at the first orientation of the movable scanner.

2. The method of claim 1, further comprising
comparing the first brightness quantity to the second brightness quantity to determine a delta brightness quantity, and
comparing first and second images to generate a subtraction map, wherein determining the motion factor includes comparing the delta brightness quantity of information related to the subtraction map.

3. The method of claim 2, the method further comprising
calculating a plurality of local mean brightness quantities based on a grid related to the subtraction map, and
calculating a plurality of local delta brightness quantities by subtracting the delta brightness quantity from each of the plurality of local mean brightness quantities, wherein determining the motion factor is based on a number of the plurality of local delta brightness quantities.

4. The method of claim 3, wherein determining the motion factor includes calculating a standard deviation quantity based on the number of the plurality of local delta brightness quantities.

5. The method of claim 3, wherein the number of the plurality of local delta brightness quantities is a predetermined number of the highest local delta brightness quantities.

6. The method of claim 3, the method further comprising selecting a natural number corresponding to the number of the plurality of local delta brightness quantities.

7. The method of claim 6, wherein the selected number of local delta brightness quantities corresponds to the highest local delta brightness quantities of the plurality of local delta brightness quantities.

8. The method of claim 3, subsequent to calculating the plurality of local mean brightness quantities, the method further comprising applying a weighting factor to at least one of the plurality of local mean brightness quantities.

9. The method of claim 8, wherein applying the weighting factor includes applying at least one of a first weighting factor related to movement of the movable scanner and a second weighting factor related to movement of the object to the at least one of the plurality of local mean brightness quantities.

10. The method of claim 9, wherein the second weighting factor is greater than the first weighting factor.

11. An apparatus for acquiring tomographic images of an object, the apparatus comprising:
a source of x-rays for directing x-rays to the object;
a detector for sensing the x-rays generated by the source;
a gantry having an axis of rotation for rotating the source and detector about the axis; and
a processor connected to the gantry, source, and detector, the processor controlling
scanning the object at a first orientation of the gantry,
scanning the object a second time at the first orientation of the gantry,
generating a first brightness quantity based on scanning the object at the first orientation,
generating a second brightness quantity based on scanning the object the second time at the first orientation, and
determining a motion factor based on the first brightness quantity, the second brightness quantity and first and second images generated at the first orientation of the gantry.

12. The apparatus of claim 11, wherein the processor is further configured to
compare the first brightness quantity to the second brightness quantity to determine a delta brightness quantity, and
compare first and second images to generate a subtraction map.

13. The apparatus of claim 12, wherein the processor is further configured to
calculate a plurality of local mean brightness quantities based on a grid related to the subtraction map, and
calculate a plurality of local delta brightness quantities by subtracting the delta brightness quantity from each of the plurality of local mean brightness quantities.

14. The apparatus of claim 13, wherein the processor is further configured to determine the motion factor by calculating a standard deviation quantity based on the number of the plurality of local delta brightness quantities.

15. The apparatus of claim 13, wherein the processor is further configured to determine a natural number corresponding to the number of the plurality of local delta brightness quantities.

16. The apparatus of claim 13, wherein the processor is configured to apply a weighting factor to at least one of the plurality of local mean brightness quantities.

17. The apparatus of claim 16, wherein the weighting factor includes at least one of a first weighting factor related to movement of the apparatus and a second weighting factor related to movement of the object.

18. The apparatus of claim 17, wherein the second weighting factor is greater than the first weighting factor.
